(19) United States
(12) Patent Application Publication
(10) Pub. No.: US 2010/0045105 A1
(43) Pub. Date: Feb. 25, 2010

(54) INTEGRATED MULTIPLE POWER CONVERSION SYSTEM FOR TRANSPORT REFRIGERATION UNITS

(75) Inventors: Stefano Bovio, Villeurbanne (FR); Andre Stumpf, Bonsecours (FR)

Correspondence Address: MARJAMA MULDOON BLASIAK & SULLIVAN LLP, 250 SOUTH CLINTON STREET, SUITE 300, SYRACUSE, NY, 13202, US

(73) Assignee: CARRIER CORPORATION, Farmington, CT (US)

(21) Appl. No.: 12/522,980

(22) PCT Filed: Jan. 31, 2007
(86) PCT No.: PCT/US2007/002739

§ 371 Date: Jul. 13, 2009

(51) Int. Cl. B60L 1/00

(52) U.S. Cl. 307/9.1

(57) ABSTRACT

The invention relates to an electrical subsystem to power a vehicle refrigeration system. The electrical subsystem includes an AC drive electrically coupled to a high voltage DC bus. The AC drive provides “refrigeration compressor AC power” responsive to a cooling demand. The electrical subsystem also includes a “low voltage DC bus”. The low voltage DC bus powers a plurality of low voltage refrigeration components including refrigeration fans. A microcontroller sets the compressor AC voltage and the compressor AC frequency. A method of preventing vehicle refrigeration system compressor stall includes the step of limiting the electrical AC power to the compressor such that the AC voltage does not droop causing a compressor stall. Also, an electrical subsystem for powering a compressor in a vehicle refrigeration system includes “V/f” operating information for the compressor, and a microcontroller commands the AC voltage and the AC frequency to the compressor.

### FIELD OF THE INVENTION

This invention relates generally to a vehicle electrical subsystem and more particularly to a vehicle electrical subsystem for powering a vehicle refrigeration system.

### BACKGROUND OF THE INVENTION

Most motor vehicles, including trucks and buses, derive power from internal combustion engines. Electrical power to run various electrical systems on the vehicles is usually generated by an electrical generator mechanically driven by the engine. Typically these electrical generators have a rotor that is mechanically coupled to a drive belt driven by the engine. AC electrical generators are the most common type of electrical power generating device used in such applications.

The advent of various types of electrical generators has allowed vehicle air conditioning systems to operate on electrical power, as opposed to using engine driven mechanical refrigeration compressors. One such early system was disclosed in U.S. Pat. No. 6,925,826, “Modular Bus Air Conditioning System”, to Hille, et al. and assigned to the Carrier Corporation. By contrast, application of vehicle electrical generators for vehicle refrigeration systems has been more problematic.

The electrical components used in a vehicle based refrigeration system are typically operated by an electrical system powered by the vehicle's main engine, usually an internal combustion engine. Parts of the refrigeration system that are powered by a low voltage DC power source, such as fans, controls, and controllers can be operated directly from the vehicle DC power system. Vehicle DC power systems are typically based on one or more batteries and configured as a 12 or 24 VDC power source to power a vehicle battery bus. When the vehicle is in transit, the vehicle's low voltage DC bus is well suited to power low voltage components of a vehicle refrigeration system. However, when the vehicle motor is stopped, the DC batteries are no longer being charged by the vehicle's battery charging system, making the vehicle DC battery bus less suitable for operating refrigeration components.

One problem is that vehicle refrigeration systems generally can not be allowed to stop working when the vehicle engine is off. Another problem is that vehicle refrigeration systems typically require more power than air conditioning systems and generally need several sources of both AC and DC voltage at several different voltages and different refrigeration subsystems generally each need a unique electrical subsystem to power them.

What is needed is an electrical subsystem to provide several sources of AC and DC power for powering a vehicle mounted refrigeration system and having a capability to operate from an AC main when the vehicle engine is off. What is also needed is a more generalized vehicle refrigeration electrical subsystem that can be used with more than one type of vehicle refrigeration system.

### SUMMARY OF THE INVENTION

In one aspect, the invention relates to an electrical subsystem to power a vehicle refrigeration system including a source of AC power to provide AC electrical power to the electrical subsystem, the source of AC electrical power comprising a source of vehicle AC electrical power in a road mode, and the source of AC electrical power comprising a source of commercial AC electrical power in a standby mode. The electrical subsystem also includes a road mode rectifier electrically coupled to the source of vehicle AC electrical power, and a standby mode rectifier electrically coupled to the source of commercial AC electrical power when in a standby mode. The road mode rectifier or the standby mode rectifier converts the source of AC power to a “high voltage DC bus”. The electrical subsystem also includes an AC drive electrically coupled to the high voltage DC bus. The AC drive provides “refrigeration compressor AC power” responsive to a cooling demand. The refrigeration compressor AC power has a compressor AC voltage and a compressor AC frequency, and the compressor AC voltage and the compressor AC frequency are responsive to a compressor control input. The electrical subsystem also includes a DC power supply electrically coupled to the high voltage DC bus. The DC power supply provides a “low voltage DC bus”. The low voltage DC bus powers a plurality of low voltage refrigeration components including refrigeration fans. The electrical subsystem also includes a microcontroller programmed to receive information related to the source of AC power, status of the vehicle refrigeration system, and cooling demand. The microcontroller is also communicatively coupled to at least the AC drive wherein the microcontroller sets the compressor AC voltage and the compressor AC frequency based on the received information.

In another aspect, the invention relates to a method of preventing vehicle refrigeration system compressor stall comprising the steps of: providing a vehicle electrical subsystem for electrically AC powering the compressor in the vehicle refrigeration system; providing an AC electrically powered refrigeration compressor; providing a source of AC power to power the vehicle electrical subsystem; monitoring a quantity of AC power available from the source of AC power; and limiting the electrical AC powering the compressor by limiting the frequency of the AC powering the compressor so that the power of the AC powering the compressor is always less by some margin than the quantity of AC power available from the source of AC power such that an AC voltage of the AC powering the compressor does not droop causing a compressor stall.

In yet another aspect, the invention relates to an electrical subsystem for powering a compressor in a vehicle refrigeration system including an AC drive unit powered by a source of AC power, the AC drive unit to provide an AC voltage having an AC frequency to the compressor. The electrical subsystem also includes a microcontroller running a program including a characteristic voltage over frequency (“V/f”) operating information for the compressor, the characteristic voltage over frequency V/f operating information relating V/f operating points to a compressor power, wherein the microcontroller commands the AC drive unit to set the AC voltage and the AC frequency to the compressor to satisfy a cooling power requirement of a refrigerated space in the vehicle refrigeration system.

### BRIEF DESCRIPTION OF THE DRAWINGS

For a further understanding of these and objects of the invention, reference will be made to the following detailed description of the invention which is to be read in connection with the accompanying drawing, where:

FIG. 1 shows a symbolic diagram of an electrical subsystem according to the invention;

FIG. 2 shows a block diagram of the exemplary electrical subsystem of FIG. 1; and

FIG. 3 shows a block diagram of an electrical subsystem compatible with various type of refrigeration subsystems.

The drawings are not necessarily to scale, emphasis instead generally being placed upon illustrating the principles of the invention. In the drawings, like numerals are used to indicate like parts throughout the various views.

### DETAILED DESCRIPTION OF THE INVENTION

Definitions: “Road mode” is defined as a condition where the refrigeration vehicle engine is running. “Standby mode” is defined as a condition where the refrigeration vehicle engine is not running and where an AC connection is made from a source of commercial AC main power to the refrigeration unit.

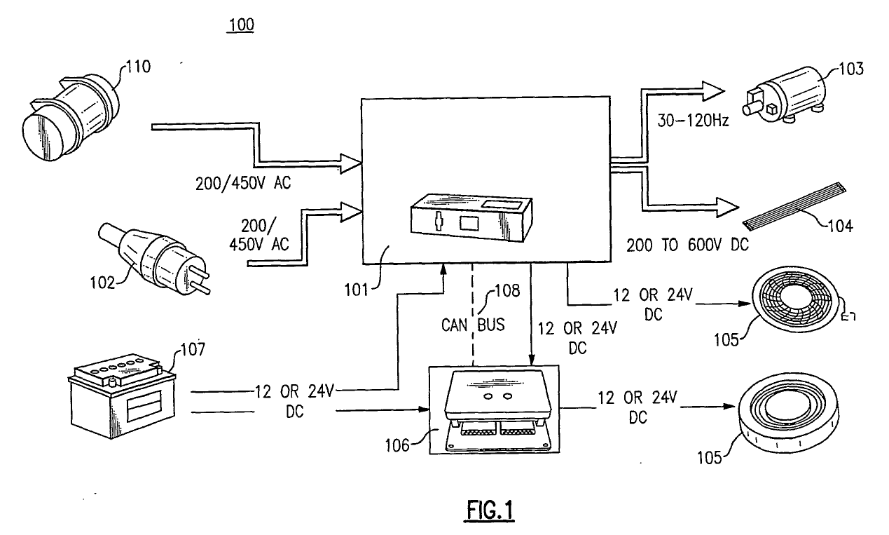

One embodiment of an electrical Sub-System 100 using an AC generator 110 is shown in FIG. 1. AC electrical power from AC generator 110, typically in a range from 150 to 400 VAC, can power AC/AC inverter 101 (an electronic power module) during “road mode” when the source of power is the vehicle's engine. AC generator 110 can be an AC generator having a rotor and a stator winding with one of the windings powered by a DC current, or it can be a conventional permanent magnet AC generator. AC generator 110 can also include optional AC voltage regulation (not shown in FIG. 1) by adjusting a rotor or a stator DC current, or by adding an additional DC regulation winding, to maintain a relatively constant AC voltage over a range of vehicle engine speeds. Such AC generator voltage regulation is an optional feature of an electrical subsystem according to the invention.

AC/AC inverter 101 can also be powered by an AC Voltage source such as AC Mains 102 when in a “standby” mode where the primary source of electrical power is from AC Mains 102 as opposed to derived from the vehicle's engine. “Mains power” is defined herein as any fixed source of AC power, such as AC power typically available in and near buildings as typically provided by a utility, other fossil fuel generators, and other source of locally generated AC power, including renewable sources such as local AC power sources based on power generated by solar panels or wind generators. For example, the exemplary 400 VAC AC mains source shown in FIG. 1, can typically be available in a range of 200 to 500 VAC as a single phase or three phase source of AC power.

AC power from AC/AC inverter 101 can be made available in a range of about 50 to 450 VAC, and over a frequency rage of about 10 Hz to 120 Hz, for uses such as powering one or more refrigeration compressors 103.

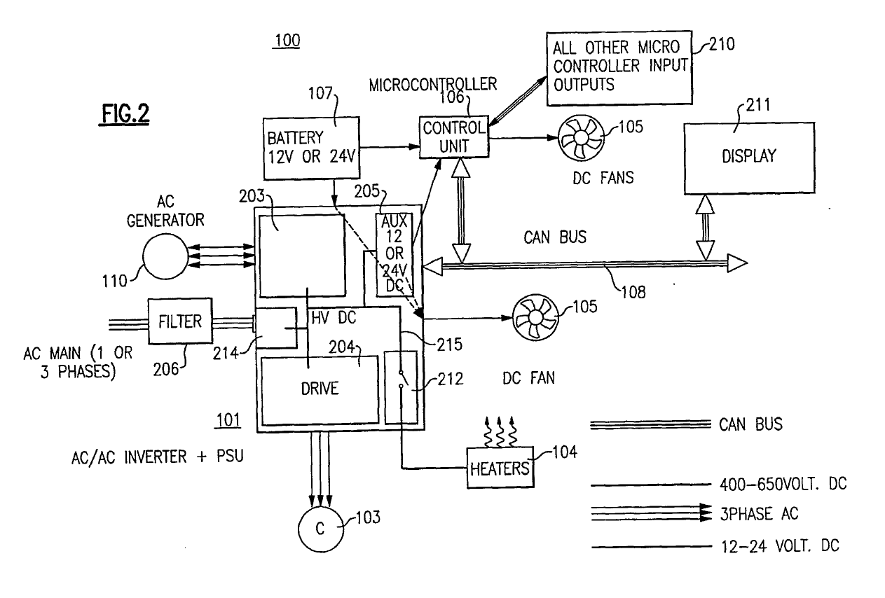

Using high voltage DC bus 215 (FIG. 2), AC/AC inverter 101, can also supply one or more DC voltages in a range of 200 V to 600 V can power one or more heaters 104, such as heaters used to defrost parts of refrigeration parts of refrigeration equipment and air conditioned spaces. The complexity of heater systems can be reduced by powering heaters 104 directly from a single high voltage DC bus as compared to heaters powered by a three phase AC bus system. Also, in some embodiments heaters can be controlled by control of the high voltage DC bus and/or by a switch 212, such as by solid state DC switching devices, thus eliminating the need for conventional relays. Another advantage of powering heaters 104 from a high voltage DC bus is that such heaters can be relatively simple resistance heaters typically only needing a protective thermostat (not shown in FIG. 1 or FIG. 2). One or more protective thermostats can typically be disposed at one or more locations on heaters 104. Such protective thermostats can provide an over temperature safety interlock, typically by causing switch control 212 to open. By contrast, some prior art AC powered heaters required more costly and complex positive temperature coefficient (“PTC”) heating elements.

AC/AC inverter 101 can also include one or more low voltage DC rectifier units, and/or DC regulated power supplies, for supplying one or more DC voltages in a range of 12 to 24 VDC for powering one or more DC operated fans 105. It is contemplated that 48 VDC can also be made available to match some newer 48 VDC vehicle electrical systems. Fans 105 can be controlled by solid state switches or relays in a controller such as shown by Microcontroller 106. One or more additional DC operated Fans 105 can be directly powered from AC/AC inverter 101. For example one or more DC operated Fans 105 directly powered from AC/AC inverter 101 can be used to cool AC/AC inverter 101 enclosure and/or one or more AC/AC inverter 101 heat sink assemblies.

Microcontroller 106 can be powered by a vehicle battery 107. By being battery powered, Microcontroller 106 can remain powered during switching between AC sources such as AC generator 110 and AC Mains 102. Microcontroller 106 can also be communicatively coupled to AC/AC inverter 101 to accomplish various control and voltage selection functions as shown by the exemplary controller area network (“CAN”) bus connection 108. Microcontroller 106 can also control the cycling of fans 105 as well as provide control, monitoring, and supervisory functions for any of the components of sub-system 100, such as via bus 108. Microcontroller 106 can be powered by a vehicle battery 107. A display 211 can be located in or on the vehicle refrigeration system and/or in a vehicle cab. Display 211 can be connectively coupled to microcontroller 106 by CAN bus 108. Other microcomputers 210, such as a microcomputer in refrigeration subsystem powered by the inventive electrical subsystem, can be also be communicatively coupled to microcontroller 106 by CAN bus 108.

FIG. 2 shows an electrical block diagram of a power generation sub-system as shown in FIG. 1. AC generator 110 can supply power to AC/AC inverter 101. Information, such as generator electrical, mechanical, and temperature values can also be sent via information wires or a data bus (not shown in FIG. 1). Shown within AC/AC inverter 101 is rectifier 203 that can supply one or more DC voltages in a range of 200 V to 600V using the power supplied by AC generator 110 in a road mode. Also shown within AC/AC inverter 101 is rectifier 214 that can supply one or more DC voltages in a range of 200 V to 600V using the power supplied by a commercial AC main in a standby mode. Both rectifiers 203 and 214 can power one or more heaters 104 and AC drive unit 204.

In the exemplary embodiment of FIG. 2, AC drive unit 204 can also supply AC power usually in a range of 50 to 450 VAC and 10 Hz to 120 Hz for powering one or more refrigeration compressors 203. AC drive unit 204 can also be customized to operate one or more types of compressor 103. With electronic control of the operation of AC drive unit 204, there is generally no need for an additional compressor motor contactor, thus further simplifying the design and improving overall system reliability. In some embodiments, AC drive 204 can use an insulated gate bipolar transistor (“IGBT”) bridge circuit topology.

Rectifier 203 can also be used to power one or more DC power units 205 that can supply DC power at 12 and/or 24 VDC. DC power units 205 can also be referred to as auxiliary (“AUX”) DC 12V and/or 24 V power supplies. A DC power unit 205 can typically include a DC to DC converter, such as a regulated switchmode DC power supply, to convert the high voltage DC from rectifier 203 to a typical vehicle compatible DC voltage of generally 12 VDC or 24 VDC. Refrigeration fans can thus be powered by a DC voltage supplied in relative isolation from other parts of the electrical subsystem, such as AC drive 204.

Such DC operation of some or all of the fans in a refrigeration subsystem is in contrast with prior art refrigeration subsystems that could suffer from undesirable interactions between a number of AC operated fans tightly coupled to a common AC bus shared with large AC loads such as a compressor 103. Such undesirable electrical interactions can be caused by the parallel reactive loads and can result in problematic or destructive system resonances. Electrical subsystem 100 completely solves the problem of fan motor interaction by using DC operated fans where the DC fans are completely decoupled from the AC power bus by a DC power supply, such as shown by DC power supply 205 power directly by rectifier 203. A DC power supply 205 can be a switch mode DC power to DC converter.

AC/AC inverter 101 can also be powered by AC main 102 via an optional AC main filter 206. Typical AC mains suitable for powering AC/AC inverter 101 include 200 VAC to 230 VAC single (mono) phase sources as well as 200 VAC to 460 VAC three phase (triphase) mains connections. There can be more than one model of AC/AC inverter 101 to be compatible with different mains voltages, or a single AC/AC inverter 101 can be made compatible with a variety of mains voltages using manual switches or automatic input AC voltage selection using relays, solid state switches, and/or circuit topologies can be used that can operate over a wide range of input voltages. AC main filter 206 can help isolate AC/AC inverter 101 from AC Main 102. Such electrical filtering can be particularly advantageous for noise and transient suppression both in terms of external disturbances and also to help prevent noise signals from AC/AC inverter 101 from entering AC Mains 102.

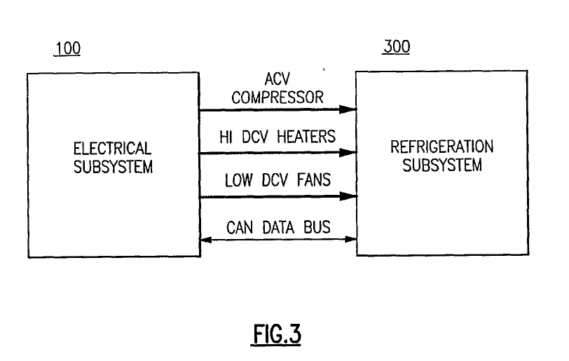

An electrical subsystem 100, such as shown in FIG. 1 and FIG. 2 can be configured so as to be adaptable to various types of vehicle refrigeration subsystems 300 as shown in FIG. 3. One aspect of matching an electrical subsystem 100 to a particular type of vehicle refrigeration subsystem 300 is to establish a list the needed AC and DC voltages. For example, whether fans need 12 VDC or 24 VDC. Such information can be conveyed from a microcomputer in the refrigeration subsystem to microcontroller 106 in electrical subsystem 100 over a communication bus, such as the CAN bus. It is also contemplated that where various type of electrical connectors electrically couple power between a refrigeration subsystem to microcontroller 106 that microcontroller 106 could configure what voltages appear at different pins using electronic or electromechanical switching devices. Alternatively, standard connector “pin-outs” and cable types can be established across different types of refrigeration subsystems 300 within a particular product line or possibly as an industry wide standard.

Also, a single electrical subsystem 100 can power multiple refrigeration subsystems 300 or one refrigeration subsystem 300 having multiple refrigerated compartments. In such cases, there can be operating situations where electrical subsystem 100 can be providing AC power to a compressor 103 for cooling one refrigerated compartment or space, while simultaneously powering a heater 104 in another refrigerated compartment or space. In such cases, power to compressor 103 and/or heater 104 can be limited so the combined electrical load does not exceed the power available to the electrical subsystem 100.

Another aspect of providing a generalized electrical subsystem 100 relates to AC drive 204. Compressors 103 typically have both a voltage amplitude and AC frequency specification that calls for an operating AC voltage and range of AC frequency. Typically a relatively constant AC voltage can be supplied to a compressor 103. The speed of the compressor (related to compressor power and cooling rate) can then be varied by varying the frequency of the AC voltage. Each type of compressor 103 has a specified Voltage over Frequency (“V/f”) operating characteristic, generally represented by one or more V/f curves. For example, a compressor 103 might be specified for a nominal operation at about 400 VAC at 90 Hz or another compressor 103 at a nominal operating point of about 300 VAC at 80 Hz. Also, each compressor 103, once the AC voltage is defined, has a range of useful operating frequencies, for example, from 35 Hz (such as for startup and the most minimal cooling needs) to 100 Hz for delivering the highest compressor shaft speed and thus a highest rate of cooling. Another aspect of generalized compatibility between an electrical subsystem 100 and various types of vehicle refrigeration subsystems 300 includes the ability of the vehicle refrigeration subsystem to convey compressor 103 AC voltage and frequency operating characteristic information to microcontroller 106, such as over a CAN data bus. For example, such operating characteristic information can be conveyed literally conveyed as data points on a V/f curve, or by conveying an identifier that causes a microcontroller 106 to select a pre-programmed V/f operating characteristic suitable for the type compressor 103 in a particular refrigeration subsystem 300. Another aspect of compatibility is for the AC drive 204 of an electrical subsystem 100 to be responsive to various compressor 103 modes of operation. For example, microcontroller 106 can be programmed such that at each compressor 103 motor start, the AC frequency gradually increases from 35 Hz to a required operating frequency (related to a compressor 103 shaft rotation speed) for soft starting. Such soft start routines can greatly limit potentially dangerous mechanical stress that could otherwise damage compressor 103.

Also, either the microcomputer in the refrigeration subsystem, or microcontroller 106, such as via CAN bus, can be set an appropriate operating AC frequency each time cooling is called for. The desired operating frequency depends on, among other factors, how far the temperature in the refrigerated space is from the temperature setpoint. A determination of an appropriate operating frequency for compressor 103 can be made either in a microcomputer in the refrigeration subsystem, where the microcomputer in the refrigeration subsystem then calls for a certain operating frequency, or alternatively with enough input information, such as how far the actual temperature in the refrigerated space differs from a current temperature setpoint, a microcontroller 106 programmed with the V/f curves or V/f data points for that compressor 103, could determine and set an appropriate frequency of the AC power delivered by an AC drive 204.

A related consideration in determining and setting an operating frequency for a compressor 103 includes consideration of a quantity (the amount) of input power available to an electrical subsystem 100. For example, during “road mode” when the vehicle's engine slows, such as at a momentary stop or at a slower vehicle speed, less power can be available from AC generator 110. If the amount of power available from AC generator 110 is less than would be needed to set a particular compressor 103 AC frequency with a corresponding AC compressor power load, an upper frequency limit responsive to power limitations can be set by microcontroller 106 to prevent exceeding the limit until the vehicle engine speed returns to a higher nominal value. If a compressor AC frequency limit is not so imposed by electrical subsystem 100, the AC voltage from AC drive 204 can droop, likely causing a compressor 103 stall. Such compressor 103 stalls can cause a catastrophic failure of the compressor and/or the compressor motor.

### EXAMPLE

A vehicle refrigeration subsystem registers a 20° C. difference between the temperature in the refrigerated space and the present temperature setpoint. The vehicle refrigeration subsystem sends a maximum compressor speed request to the vehicle electrical subsystem. In the vehicle refrigeration system of the example, a maximum compressor speed request presents a 4 kilo Watt load to the electrical subsystem at a compressor AC frequency of 60 Hz. However, the microcontroller in the electrical subsystem, aware that only 3 kilo Watts is available to power the electrical subsystem at that moment, limits the compressor frequency to 40 Hz, thus preventing a compressor stall.

The term “microcontroller”, as used in reference to microcontroller 106, is defined herein as synonymous with, and interchangeable with, “micro controller”, “controller module”, and “microcomputer”. It is understood that a microcontroller typically includes a “microprocessor”, and/or any other integrated devices, such as “digital signal processor” (DSP) chips and “field programmable logic arrays” (FPGA) which can be programmed to perform the functions of a microcomputer.

It should be noted that while the inventive systems have been generally described as powering a generator using mechanical energy derived from a vehicle engine, other sources of mechanical energy can be used to rotate electrical generator rotors. For example, an electric vehicle motor can by used in place of an internal combustion engine in any of the embodiments described herein.

While the present invention has been particularly shown and described with reference to the preferred mode as illustrated in the drawing, it will be understood by one skilled in the art that various changes in detail may be effected therein without departing from the spirit and scope of the invention as defined by the claims.

We claim:

1. An electrical subsystem to power refrigerated compartment or space comprising:
a source of AC power to provide AC electrical power to the electrical subsystem, the source of AC electrical power comprising a source of vehicle AC electrical power in a road mode, and the source of AC electrical power comprising a source of commercial AC electrical power in a standby mode;
a road mode rectifier electrically coupled to the source of vehicle AC electrical power, and a standby mode rectifier electrically coupled to the source of commercial AC electrical power when in a standby mode, the road mode rectifier or the standby mode rectifier to convert the source of AC power to a “high voltage DC bus”;
an AC drive electrically coupled to the high voltage DC bus, the AC drive providing “refrigeration compressor AC power” responsive to a cooling demand, the refrigeration compressor AC power having a compressor AC voltage and a compressor AC frequency, the compressor AC voltage and the compressor AC frequency responsive to a compressor control input;
a DC power supply electrically coupled to the high voltage DC bus, the DC power supply to provide a “low voltage DC bus”, the low voltage DC bus to power a plurality of low voltage refrigeration components including refrigeration fans; and
a microcontroller programmed to receive information related to the source of AC power, status of the vehicle refrigeration system, and cooling demand, the microcontroller also communicatively coupled to at least the AC drive wherein the microcontroller sets the compressor AC voltage and the compressor AC frequency based on the received information.

2. The subsystem of claim I, wherein the source of vehicle AC power is an AC generator powered by a vehicle engine.

3. The subsystem of claim 2, wherein the AC generator source of AC power further comprises an AC generator voltage regulation.

4. The subsystem of claim 1, wherein the AC drive comprises insulated gate bipolar transistors (“IGBT”).

5. The subsystem of claim 1, wherein the high voltage DC bus also provides power to one or more electrical resistance heaters in the vehicle refrigeration system.

6. The subsystem of claim 1, wherein the road mode rectifier, the standby mode rectifier, the AC drive, and the DC power supply are co-located in a common enclosure and the subsystem further comprises a DC operated fan powered by the DC power supply or a vehicle battery to cool the enclosure.

7. The subsystem of claim 1, wherein the DC power supply comprises a regulated DC to DC switchmode power supply having at least a 12 VDC or a 24 VDC low voltage DC power output.

8. The subsystem of claim 1, wherein the high voltage DC bus has a DC voltage in a range of about 200 V to 600 V.

9. The subsystem of claim 1, wherein the compressor AC voltage ranges from about 50 VAC to 450 VAC and a compressor AC frequency ranges from about 10 Hz to 120 Hz.

10. The subsystem of claim 1, wherein the electrical subsystem has a “road mode” where the electrical subsystem receives power from an AC generator powered by a vehicle engine and a “standby mode” where the electrical subsystem receives power from an AC mains source external to the vehicle.

11. The subsystem of claim 10, wherein a low voltage DC load is powered by the low voltage DC bus, the low voltage DC bus powered by a vehicle battery while in the road mode and by the DC power supply when in the standby mode.

12. The subsystem of claim 1, wherein the electrical subsystem powers a refrigeration subsystem comprising a plurality of refrigerated spaces, wherein at least one of the spaces is heated by one or more heaters while another of the plurality of refrigerated spaces is cooled by a compressor, and so as to not exceed a power available to the electrical subsystem at least a selected one of:
the high voltage DC bus power is limited to at least one of the one or more heaters; and
the refrigeration compressor AC power is limited to the compressor.

13. A method of preventing vehicle refrigeration system compressor stall comprising the steps of:
providing a vehicle electrical subsystem for electrically AC powering the compressor in the vehicle refrigeration system;
providing an AC electrically powered refrigeration compressor;
providing a source of AC power to power the vehicle electrical subsystem;
monitoring a quantity of AC power available from the source of AC power; and
limiting the electrical AC powering the compressor by limiting the frequency of the AC powering the compressor so that the power of the AC powering the compressor is always less by some margin than the quantity of AC power available from the source of AC power such that an AC voltage of the AC powering the compressor does not droop causing a compressor stall.

14. An electrical subsystem for powering a compressor in a vehicle refrigeration system comprising:
an AC drive unit powered by a source of AC power, the AC drive unit to provide an AC voltage having an AC frequency to the compressor; and
a microcontroller running a program including a characteristic voltage over frequency (“V/f”) operating information for the compressor, the characteristic voltage over frequency V/f operating information relating V/f operating points to a compressor power, wherein the microcontroller commands the AC drive unit to set the AC voltage and the AC frequency to the compressor to satisfy a cooling power requirement of a refrigerated space in the vehicle refrigeration system;
wherein the characteristic voltage over frequency V/f operating information for the compressor comprises pre-programmed V/f operating information for the compressor and the microcontroller selects the appropriate V/f operating information for the compressor based on an identifier that identifies a particular type of refrigeration system that includes a particular type of the compressor.

15. The electrical subsystem of claim 14, wherein the cooling power requirement of a refrigerated space in the vehicle refrigeration system is determined based on the difference between a measured temperature in the refrigerated space and a refrigerated space temperature setpoint.

16. The electrical subsystem of claim 14, wherein each time the compressor is commanded “on”, the AC frequency is ramped up in a “soft start” from 0 Hz to at least a minimum operating frequency in a range of about 30 Hz to 40 Hz.

17. The electrical subsystem of claim 16, wherein the AC frequency is further increased from the minimum operating frequency to a desired operating frequency based on a desired rate of cooling, wherein the desired operating frequency is limited to a maximum frequency, the maximum frequency in a range of about 70 Hz to 120 Hz.

18. (canceled)

19. The electrical subsystem of claim 14, wherein the characteristic voltage over frequency V/f operating information for the compressor comprises V/f data received over a data bus from the refrigeration system.

20. The electrical subsystem of claim 14, wherein a plurality of electrical subsystem AC and DC voltages for powering the refrigeration system are set based on data received over a data bus from the refrigeration system.
